(19) United States
(12) Patent Application Publication
(10) Pub. No.: US 2011/0259613 A1
(43) Pub. Date: Oct. 27, 2011

(54) FIRE PROTECTION AND COOLING SYSTEM

(75) Inventor: Darren James Morris, Preston (GB)

(73) Assignee: COOLFIRE TECHNOLOGY LIMITED, Bolton (GB)

(21) Appl. No.: 12/937,409

(22) PCT Filed: Apr. 9, 2009
(86) PCT No.: PCT/GB09/00953

§ 371 Date: Dec. 20, 2010

(30) Foreign Application Priority Data
Apr. 11, 2008 (GB) 0806650.8

(51) Int. Cl. A62C 35/64

(52) U.S. Cl. 169/16; 137/357

(57) ABSTRACT

The present invention relates to an integrated fire protection and cooling system which operates with water under high pressure for use in combating fires in buildings, particularly in buildings where total flooding which can be caused by conventional sprinkler systems is especially undesirable and damaging, and also to a fire protection system that utilises a fire sprinkler piping system to distribute cooling liquids to provide a central cooling system to a building.

The present invention relates to an integrated fire protection and cooling system which operates with water under high pressure for use in combating fires in buildings, particularly buildings such as in art galleries or listed buildings where total flooding which can be caused by conventional sprinkler systems is especially undesirable and damaging, and also to a fire protection system that utilises a fire sprinkler piping system to distribute cooling liquids to provide a central cooling system to a building.

Traditionally, if an owner of a building wanted to substantially improve the safety and protection of the building, investment could be made in installing a fire sprinkler system. This would require installation of fire sprinkler heads in each room of the building and installing a dedicated piping system from a water source to the heads. While the value of these systems in the savings of human lives and property has been priceless, such installations are expensive.

Conventional fire sprinkler systems used in buildings throughout the world employ water at atmospheric pressure. However, this requires a significant amount of water to extinguish a fire. There is hence a large water storage requirement. This is a problem in the modern age where space is at a premium in many properties.

Additionally, the more water is used in extinguishing a fire, the more damage will be caused by the water to surrounding equipment or furnishings in the property as it can end up being flooded rather than incinerated.

Also, traditionally, adding air conditioning to existing buildings has been done in one of three ways:

i) Installing packaged through-the-wall air conditioners (usually very unsightly and energy inefficient); or
ii) Installing split air conditioning systems with refrigerant piping running to each room (expensive and energy inefficient); or
iii) Installing what is known in the art as a two pipe cooled water system (more energy efficient than (i) or (ii) but also expensive).

The two pipe system consists of a cooling plant and a dedicated cooled water supply and return piping system. The cooling plant supplies cold water through a first dedicated piping system that distributes the cold water throughout the building. Similarly, a second dedicated piping system collects the used cold water and returns it to the cooling plant. Individual fan coil units placed at various locations throughout the building provide for zonal temperature control. Cooling is provided by having the fan circulate air over a coil that is accessing the cold water piping system. While the two pipe fan coil system provides zonal temperature control, economy of operation, low maintenance, and minimum noise, there is a high construction cost involved.

Therefore, to install both air conditioning and a fire sprinkler system requires a significant financial outlay.

To avoid the high cost of dedicated two pipe fan coil units in addition to dedicated fire sprinkler systems, the present invention demonstrates a new way of integrating the two pipe chilled water system with an effective high pressure life safety system.

Existing technology in combining building heating and cooling needs with the fire sprinkler systems has been focused on new buildings, where both heating and cooling would be desirable. For the large stock of existing buildings where heating systems have already been installed, these combined systems would provide an unnecessary and expensive duplication of heating systems.

One combination of a heating/cooling and fire suppression system is shown in U.S. Pat. No. 3,939,914 to Carroll. A cooling plant and a heating plant are connected to a single piping system. The piping system is also used for fire suppression purposes. However, because only a single piping system is utilised, the water flowing therein must be at a single temperature. Thus, in order to selectively heat and cool different zones of the building, a plurality of compressor type heat exchangers must be located throughout the building. The use of the compressor type heat exchangers allows heating and cooling from a single temperature fluid. However, compressor type heat exchangers are costly, require high maintenance and are relatively noisy.

A combination of a heating/cooling and fire suppression system with a domestic hot water system is shown in U.S. Pat. No. 5,183,102 to Clark. While this approach avoids the need for compressor type heat exchangers, integration of the domestic water system in an existing building is normally unacceptable and unnecessary.

Furthermore, neither of the above inventions nor any other such existing technology adequately safeguards the fire sprinkler system in the event of a failure of the cooling components of the system.

Further, the above inventions and other such existing technology utilises electrical energy consuming devices like heat pumps and fan coils to transfer the heat energy from the space.

Further, such existing technology requires separate supply and return branch piping to circulate water to fan coils on different levels.

The present invention overcomes one or more of the above drawbacks.

Therefore, according to the present invention there is provided a system for providing fire protection and cooling for a building having a piping system suitable for forming a dual use fire sprinkler/chilled water piping system, the system comprising a water cooling arrangement for supplying and maintaining water in the piping system at a first temperature and a plurality of thermally driven heat extraction assemblies located throughout the building, the heat extraction assemblies being thermally linked to the water at the first temperature from the piping system wherein each of the heat extraction assemblies includes a radiant, natural convective or forced convective arrangement, which act to transfer heat at a second temperature which is substantially higher relative to the first temperature to water in the heat extraction assembly, and wherein the water is distributed from the fire sprinkler at a pressure of at least about 8 bar.

The water distributed from the fire sprinklers is typically under a pressure of at least about 8-9 bar up to about 25 bar, but may be kept at any level of pressure therebetween, such as at least about 10, 12, 14, 16, 18, 20 or 22 bar (1 bar=1.0197 kg/cm).

By distributing water from the fire sprinklers under high pressure, the present invention allows for a reduced water storage requirement. This results in a cost saving for customers as only smaller tanks need to be purchased, and it also saves on space when the tanks are installed. This is valuable where space is at a premium in many properties.

Additionally, running the system at a higher pressure reduces the amount of water required to extinguish a fire, thus causing less water and flooding damage to the property and its surroundings.

The invention is particularly suited to be used in buildings where total flooding is undesirable, such as in art galleries or listed buildings. It is also more suitable for computer suites, lift motor rooms or any small areas where there are high value goods or electrical equipment.

For smaller buildings and areas to be protected, pressurised water cylinders may be used instead of pumps and/or water storage tanks.

The system of the invention employs high pressure nozzles instead of sprinkler heads. This allows for a reduction of the maximum number of heads needed for any given system.

Existing pipe systems can be upgraded to cope with the elevated water pressure levels required by the invention, so complete new installations of systems are not necessary.

The cooling piping system is shared with the fire sprinkler piping system in the case of cold water. By having one integrated piping system, specific zonal control of temperature can be achieved by the use of simple fan coils, and life safety and property protection from fire can be achieved by utilizing fire sprinkler heads. Moreover, because the piping systems are integrated to more readily fit into systems in existing buildings, it can be appreciated that the cost of installing such a fire protection and cooling system is relatively low, thus making it more enticing to the building owner.

The heat extraction assemblies typically include a valve arrangement that meters the flow of the water to the heat extraction assemblies under normal conditions and closes off under a loss of pressure situation.

The heat extraction assemblies also typically include a first tubing network for carrying the water at the first temperature, and a second tubing network for carrying water at the second temperature and a set of radiating fins, whereby both the first tubing network and the second tubing network are connected to the set of radiating fins to allow thermal transfer to occur. Typically, the first temperature before air cooling may typically be between about 5-8° C., more typically about 6° C., while the second temperature after air cooling may typically be between about 10-14° C., more typically about 12° C.

By “substantially higher” for the second temperature in relation to the first temperature, it is meant that the second temperature is at least about 4° C. higher than the first temperature, more typically at least about 6, 7 or 8° C. higher.

Advantageously the heat extraction assemblies may further include a radiant cooling arrangement.

Advantageously, the heat extraction assemblies may further include a natural convection cooling arrangement.

The heat extraction assemblies may further include a fan or a forced airflow arrangement.

The water cooling arrangement is typically linked to heat extraction devices at different locations in the building using a single pipe. The water cooling arrangement is usually a heat exchanger that is connected to a ground water supply source or other geothermal heat sink, such as a hydronic snowmelt system. Advantageously, the water cooling arrangement has a water cooler outlet and a water cooler inlet, the water cooler outlet supplying water into a first piping system and the water cooler inlet receiving water from the first piping system the water at the first temperature optionally continuously circulated by a cold water pump through to the system.

The first piping system typically carries fluid used exclusively for fire suppression purposes and cooling the building.

In accordance with a second aspect of the connection there is provided a system for cooling a building comprising a water cooling arrangement for providing water at a first temperature, the water cooling arrangement having a cooler outlet and a cooler inlet, a first piping network for carrying the water at the first temperature, the first piping network receiving the water via the cooler outlet and returning the water to the water cooling arrangement via the cooler inlet, the first piping network further having a plurality of release valves for releasing water, the first piping network comprising a fire sprinkler system for the building and a plurality of heat transfer assemblies located at different locations throughout the building, the heat transfer assemblies being thermally linked to water at the first temperature from the first piping network, wherein each of the heat transfer assemblies, act to transfer heat at the second temperature to the water at the first temperature, wherein the water is distributed from the fire sprinkler system at a pressure of at least about 8 bar.

The second heat transfer assemblies typically include a first tubing network for carrying the water at the first temperature, and a second tubing network for carrying water at the second temperature and further comprise a set of radiating fins, whereby both the first tubing network and the second tubing network are connected to the set of radiating fins whereby thermal transfer may occur.

The heat transfer fan coil assemblies typically further include a valve arrangement for controlling the flow of water to the first tubing network and the second tubing network.

The water cooling arrangement is a heat exchanger that accesses a ground water supply source. Alternatively, cooling could be provided in some parts of the world during some seasons by rejecting heat through a series of tubes buried in or beneath sidewalks and driveways near the building. This heat rejection system could offer the additional benefit of melting snow from these surfaces, further enhancing safety.

The first piping network typically carries fluid for fire suppression purposes and for cooling the building.

Advantageously, the present invention incorporates a flow valve design that meters the flow of cooling water to the fan coils under normal cooling operation. If there is a failure in the cooling piping system downstream of this valve, it is engineered in a manner so as to fail to a shut-off position thereby preventing the loss of fluid from the fire sprinkler system.

The present invention also includes the option of using radiant heat absorption and natural convection cooling as a method of heat extraction. This approach, coupled with geothermal cooling, in some areas of the world could provide cooling without the need for any mechanical refrigeration and the associated refrigerants and energy use. Additional advantages could be added by coupling this system with other geothermal based systems such as ground water irrigation systems or hydronic snowmelt systems.

The invention incorporates a single pipe scheme that can serve multiple levels of heat extraction devices. This piping scheme not only reduces the number of pipes that must be installed but uses the water twice for cooling, thereby reducing the needed cooling flow by 50%. This in turn reduces pipe sizes, pump sizes and pump energy requirements.

According to one embodiment of the invention, in the event of a fire, the water which is supplied to the nozzles under pressures of at least about 8 bar is delivered from the nozzles as a jet of a water mist. The water is delivered rapidly from the nozzles in this form and expands to cover and extinguish the flames and to lower the temperatures of any items in the building to below combustion temperature.

According to another aspect of the invention, there is provided a method of providing fire protection and cooling for a building using a system as hereinbefore defined.

The invention will now be described further by way of example with reference to the following figure which is intended to be illustrative only and in no way limiting upon the scope of the invention.

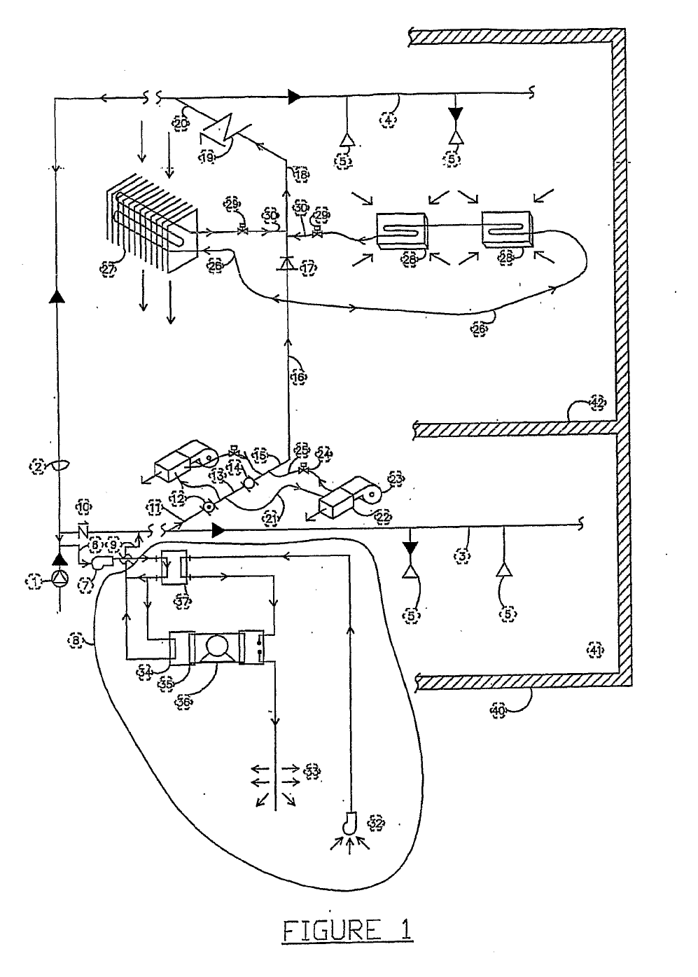

FIG. 1 is a schematic view of the present invention for a two floor building incorporating the present invention using ground water directly as a cooling source and radiant and convective cooling to deliver the cooling effect to the space without the use of compressors or fans. Also shown is an embodiment of the automatic shut off valve and the single pipe riser designed for use in the invention.

Referring to FIG. 1, a portion of an existing multi-floor building is generally shown by reference numeral 40. The portion of the building shown includes a ground floor 41 and a second floor 42. For the purpose of life safety and for property protection from fire, a fire sprinkler piping system is to be integrated therein. In FIG. 1, the fire sprinkler piping system is generally comprised of a cold water service entry 1, a cold water supply riser 2, a cold water supply main 3 serving the lower floor 41, a cold water supply main 4 serving the upper floor 42, a plurality of cold water supply branches and a plurality of release valves 5.

The fire sprinkler piping system described herein provides a continuously circulating water supply. Specifically, still referring to FIG. 1, a water cooler 8 is integrated into the fire sprinkler piping system. In the illustrated embodiment, the water cooler 8 is a heat exchanger that utilises ground water accessed via a well in order to cool the water in the fire sprinkler piping system. In operation, a pump 32 circulates ground water into the water cooler 37 via a separate independent piping network. Also circulating within water cooler 37 is the water in the fire sprinkler piping system. By known thermodynamic processes, the water in the fire sprinkler piping system is cooled to nearly the temperature of the ground water.

Although described above is one type of water cooler, it can be appreciated by those skilled in the art that other methods of cooling the water in the fire sprinkler piping system may be utilised, such as a mechanical cooler, a thermal storage device, or a combination of cooling sources as shown in FIG. 1, with water cooler 8. This shows water being cooled directly in heat exchanger 37 by ground water pumped under pressure by pump 32, and the ground water then cools a mechanical cooler 34, 35, and 36 and returns to ground 33. The evaporator of the mechanical cooler 34 can further cool the cold water for use in cooling the building. An additional option to provide space cooling during cool weather is to transfer the heat energy via a heat exchanger to a series of tubes buried in or beneath pavements and driveways, thereby providing both building heat rejection and a snow melt system.

A cold water pump 7 maintains circulation of the cold water in the fire sprinkler piping system. The cold water pump 7 draws water via pipe 6 from cold water supply riser 2 and acts to circulate cold water vertically down the cold water supply riser 2. Distribution of water to a lower floor is accomplished by the cold water supply 9 which feeds branch 3 that generally runs laterally from the cold water supply riser 2. For simplicity, only one cold water supply branch is shown for each floor; however, it can be appreciated that a plurality of cold water branches may be utilised, and multiple floors may be served in a similar manner. In communication with each cold water supply branch 3 are cooling water supply riser branches 11, 15, 16, 18, 20 that supply the water to the cooling terminal units 22, 27, & 28 as well as returning the water to the cold water return main 4. The cold water return main 4 returns the water back to water cooler 8 where the water is cooled and returned back into cold water supply main 3. In summary, water is circulated from the water cooler 8, through the cold water supply main 3, up the cold water supply branch 11, returning to the cold water return main 4, down cold water return riser 2, and back to water cooler 8. The directions of the water flow during cooling are represented bu the small arrows along the lines of flow.

Risers 2 and 16 are typically located in the interior walls of the building. The cold water supply mains are typically located above the ceiling on each floor. The cold water branches 21 and 26 are typically located above the ceilings on each floor, and are, in a typical embodiment of the invention, constructed of tubular piping. The release valves 5 are incorporated into the cold water branches 3 and 4 and extend downwardly into the interior of each floor such that emergency fire suppression may be accomplished.

Although FIG. 1 shows two release valves 5 per floor, it can be appreciated that more may be utilised. As is known in the art, release valves 5 allow water in the cold water branches 3 and 4 to flow outward when a fire is detected, thereby suppressing the fire. The heavy dark flow arrows indicate water flow in the fire suppression mode.

The release valves 5 have high pressure nozzles (not shown) for distributing the water under elevated pressure, rather than conventional sprinkler heads.

For simplicity, the fire sprinkler piping system has been described and shown as a closed loop system, whereby the same water is circulated continuously within the fire sprinkler piping system. However, it can be appreciated that an outside water source must be available for replenishing the water in the fire sprinkler piping system during fire suppression. For example, a local water main is connected to cold water service entry 1. The cold water service entry may then inject water from the local water main into the fire sprinkler piping system when necessary.

The present invention utilises the above described piping system to cool the building. Located throughout the building are a plurality of heat extraction devices 22, 27 and 28. The heat extraction devices are the actual cooling sources within the building.

Although FIG. 1 shows only two floors of a multi-floor building with two heat extraction devices for each floor, it should be appreciated that the present invention is intended to be utilised for single-floor and multi-floor buildings of any number of floors and with any number of heat extraction devices located throughout each floor as is deemed necessary.

FIG. 1 shows three different types of heat extraction devices. On the first floor are shown fan coils consisting of a fan 23 and a cooling coil 22. In this heat extraction device the fan draws air from the space and forces the air through the cooling coil 22. At the same time the cooling control valve 24 opens up allowing cold water to flow into tubing 21, pass through the cooling coil 22 and exit through tubing 25. Through the thermodynamic process known as forced convection the warm air is cooled by heat transfer through the cooling coil 22 and the heat is carried away by the cold water supply. The cold water then returns to cold water riser 15. The second floor of the building demonstrates two alternative heat extraction devices; number 27 is a convective cooling coil, and numbers 28 are two radiant cooling panels. The cold water enters the convective cooling coil through tube 26 and cools the thin material of the convector. This cool material cools the surrounding air of the coil, which grows heavier, and drops from the coil. This draws warmer air in to the top of the convective cooler as the process continues. Warmer water leaves through conduit 30. This process continues as long as control valve 29 is in the open condition. When sufficient cooling has been achieved control valve 29 will then close. A similar process is shown on the other side of the second floor 42 of the building 40 shown in FIG. 1. The heat extraction devices shown here are radiant panels which absorb radiant energy from surrounding space. Again these panels become operational when cold water flows through tube 26 into the radiant panels cooling them below the temperature of the surrounding space. Warmth radiates in from surrounding objects heating the cold water as it passes through the panel. The water then leaves through conduit 30 whenever control valve 29 is in the open position.

Several unique piping features are also illustrated in FIG. 1. First is the flow metering/automatic shut off valve 12 located immediately adjacent cold water branch 11 which connects to cold water supply main 3. This valve has two main functions. Under normal cooling operations, valve 12 is able to control the total flow into branch 11 at a constant preset quantity of cold water. Cold water flow can drop below this amount but this valve limits the flow so that it does not rise above the preset amount. However, if there should be a failure of equipment or piping downstream of flow metering, valve 12 will sense a loss of pressure in the downstream line and will fail to a closed position. This feature protects the fire sprinkler system in the case of a failure in the piping in the cooling sections of the system.

Flow metering valve 14 has the function of letting a specified minimum flow bypass the fan coils on the lower level and go directly to riser 16 to serve the fan coils on the upper level. Additionally due to the flow restrictions of this valve the cold water is forced to flow to the heat extraction devices on this floor through tubing 21 and return beyond this valve through tubing 25.

Flow diversion bypass valve 17 is located on the upper floor and creates a closed restriction to flow from riser 16 up to riser 18 if alternative paths are available through tube 26. This forces the cold water to flow through tube 26 and through heat extraction devices 27 or 28. Whenever control valve 29 is open, water then returns through conduit 30 back into cold water supply riser 18. However if all control valves 29 are in the closed position this will result in a build up of pressure upstream of valve 17 and valve 17 will then open to let cold water flow through to riser 18. This feature allows cooling to take place on the lower floor even if no cooling is required on the upper floor. Through proper sizing of valves 12, 14, and 17, cooling water can be adequately distributed to both the lower and upper floors using a single pipe. This again reduces the insulation cost of running separate supply and return piping risers from floor to floor as is the conventional approach. Cold water from riser 18 is allowed to pass through a non-return or check valve 19 before passing through conduit 20 and returning to cold water return main 4. Water is then allowed to circulate back down through cold water return riser 2 and back to cold water circulating pump 7, thereby completing a loop.

If cooling is desired, cold water valves 24 or 29 are opened to allow water from cold water supply branch 11 or 16 to flow into the cold water tubing 21 or 26 to flow to heat extraction devices 22, 27 or 28. Heat is transferred via known thermodynamic processes of forced convection, natural convection or radiation from the air to the water. The water is returned by cold water control valve 24 or 29 and via the tubing 25 or conduit 30 to cold water riser 15 or 18.

As can be seen in the description above, zonal temperature control may be accomplished by utilizing a plurality of heat extraction devices. Moreover, in contrast to the prior art, heat extraction devices 22, 27 and 28 are relatively simple in manufacture as compared with compressor type heat exchangers operating from a single temperature fluid. As can be appreciated by those skilled in the art, a single temperature fluid heating and cooling system requires a complex heat exchanger including an evaporator and compressor in order to generate cooling or heating from a single temperature fluid.

Additionally, the compressor type heat exchangers require large amounts of power and are relatively noisy. In contrast, the fan coil assemblies 22 and 23 require only a small amount of power to drive the fan, and convective heat extraction device 27 and radiant heat extraction device 28 both require no power input. By having a cold water supply to each heat extraction assembly, cooling can be accomplished without the expense of having a plurality of evaporators and compressors. Moreover, by utilizing the fire sprinkling system to carry the cold water supply, additional savings are realized. Specifically, initial building costs are greatly reduced by eliminating the need for dedicated piping systems.

It is of course to be understood that the present invention is not intended to be restricted to the foregoing example which is described by way of example only.

1. A system for providing fire protection and cooling for a building having a piping system suitable for forming a dual use fire sprinkler/cooled water piping system, the system comprising a water cooling arrangement for supplying and maintaining water in the piping system at a first temperature and a plurality of thermally driven heat extraction assemblies located throughout the building, the heat extraction assemblies being thermally linked to the water at the first temperature from the piping system wherein each of the heat extraction assemblies includes a radiant, natural convective or forced convective arrangement, which act to transfer heat at a second temperature which is substantially higher relative to the first temperature to water in the heat extraction assembly, and wherein the water is distributed from the fire sprinkler at a pressure of at least about 8 bar.

2. A system according to claim 1, wherein the water is distributed from the fire sprinkler at a pressure of at least about 16 bar.

3. A system according to claim 1, wherein the water is distributed from the fire sprinkler through high pressure nozzles.

4. A system according to claim 1, wherein pressurised cylinders are used to store and supply the water.

5. A system according to claim 1, wherein the heat extraction assemblies include a valve arrangement that meters the flow of water to the heat extraction assemblies under normal conditions and closes off under a loss of pressure condition.

6. A system accordingly to claim 1, wherein the heat extraction assemblies include a first tubing network for carrying the water at the first temperature, and a second tubing network for carrying the water at the second temperature and a set of radiating fins, whereby both the first tubing network and the second tubing network are connected to the set of radiating fins to allow thermal transfer to occur.

7. A system according to claim 1, wherein the heat extraction assemblies include a radiant cooling arrangement.

8. A system according to claim 1, wherein the heat extraction assemblies further include a natural convection cooling arrangement.

9. A system according to claim 1, wherein the heat extraction assemblies further include a fan or a forced air flow arrangement.

10. A system according to claim 1, wherein the water cooling arrangement is linked to heat extraction devices at different locations in the building using a single pipe.

11. A system according to claim 10, wherein the water cooling arrangement is a heat exchanger which is connected to a ground water supply source.

12. A system according to claim 10, wherein the water cooling arrangement has a water cooler outlet and a water cooler inlet, the water cooler outlet supplying water into the first piping system and the water cooler inlet receiving the water from the first piping system, the water at the first temperature being continuously circulated by a cold water pump through the system.

13. A system according to claim 1, wherein the first piping system carries fluid used exclusively for fire suppression purposes and cooling the building.

14. A system for cooling a building comprising water cooling arrangement for providing water at a first temperature, the water cooling arrangement having a cooler outlet and a cooler inlet, a first piping network for carrying the water at the first temperature, the first piping network receiving the water via the cooler outlet and returning the water to the water cooling arrangement via the cooler inlet, the first piping network further having a plurality of release valves for releasing water, the first piping network comprising a fire sprinkler system for the building and a plurality of heat transfer assemblies located throughout the building, the heat transfer assemblies being thermally linked to water at the first temperature from the first piping network, wherein each of the heat transfer assemblies act to transfer heat at a second temperature to the water at the first temperature, wherein the water is distributed from the fire sprinkler system at a pressure of at least about 8 bar.

15. A system according to claim 14, wherein the water is distributed from the fire sprinkler system at a pressure of at least about 16 bar.

16. A system according to claim 14, wherein the water is distributed from the fire sprinkler system through high pressure nozzles.

17. A system according to claim 14, wherein pressurised cylinders are used to store and supply the water.

18. A system according to claim 14, wherein the second heat transfer assemblies include a first tubing network for carrying the water at the first temperature, and a second tubing network for carrying water at the second temperature and further comprising a set of radiating fins, whereby both the first tubing network and the second tubing network are connected to the set of radiating fins whereby thermal transfer may occur.

19. A system according to claim 14, wherein the heat transfer fan coil assemblies further include a valve arrangement for controlling the flow of water to the first tubing network and the second tubing network.

20. A system according to claim 14, wherein the water cooling arrangement comprises a heat exchanger that accesses a ground water supply source.

21. A system according to claim 14, wherein first piping network carries fluid used exclusively for fire suppression purposes and cooling the building.

22. (canceled)

23. (canceled)
